(19) United States
(12) Patent Application Publication
(10) Pub. No.: US 2023/0307879 A1
(43) Pub. Date: Sep. 28, 2023

(54) SURGE PROTECTOR WITH ANTI-OFF STRUCTURE

(71) Applicant: XIAMEN SET ELECTRONICS CO., LTD., Xiamen (CN)

(72) Inventors: Jian YE, Xiamen (CN); Xianggui ZHANG, Xiamen (CN); Anping CAO, Xiamen (CN)

(73) Assignee: XIAMEN SET ELECTRONICS CO., LTD., Xiamen (CN)

(21) Appl. No.: 18/018,887

(22) PCT Filed: Aug. 13, 2021
(86) PCT No.: PCT/CN2021/112582

§ 371 Date: Jan. 31, 2023

(30) Foreign Application Priority Data
Nov. 11, 2020 (CN) 202022592346.9

(51) Int. Cl. H01R 33/97; H01R 13/627

(52) U.S. Cl. CPC H01R 33/97; H01R 13/6278; H01R 33/05

(57) ABSTRACT

A surge protector with an anti-off structure includes a pluggable module and a base. The base includes external terminal connection parts on both sides. The top of the external terminal connection part of the base is provided with a sliding limit device. Both sides of the pluggable module are provided with limit protruding blocks. The sliding limit device includes a hole cover, and the hole cover is slidably connected to the top of the external terminal connection part. When the pluggable module is completely inserted, a part of the hole cover protrudes into the pluggable module installation slot and is clamped with a fixing limit device of the pluggable module to limit the pluggable module from being detached from the base. When the pluggable module is removed, the hole cover is moved toward both sides, such that the hole cover is separated from the fixing limit device.

### CROSS-REFERENCE TO THE RELATED APPLICATIONS

This application is the national phase entry of International Application No. PCT/CN2021/112582, filed on Aug. 13, 2021, which is based upon and claims priority to Chinese Patent Application No. 202022592346.9, filed on Nov. 11, 2020, the entire contents of which are incorporated herein by reference.

### TECHNICAL FIELD

The present disclosure relates to the technical field of surge protectors, and more particularly, to a surge protector with an anti-off structure.

### BACKGROUND

To facilitate the replacement of failed components, a pluggable mechanism is adopted in the surge protector and includes a base and a pluggable module of the surge protector. Additionally, the surge protector adopts a clamping manner to facilitate assembly, which can improve assembly efficiency. To facilitate the insertion and removal operation, the cooperation of the protruding point/protruding edge and the groove is generally adopted. The insertion and removal of the pluggable module can be achieved by overcoming the resistance of the deformation of the housing when the pluggable module of the surge protector needs to be inserted and removed. Therefore, the deformation resistance of the housing is generally made to be small, resulting in an unstable assembly. That is, once the cooperation of the clamping fails, the two parts are easily separated from each other.

### SUMMARY

Given the above shortcomings in the prior art, an objective of the present disclosure is to provide a surge protector with an anti-off structure to achieve a more reliable and stable clamping manner.

To achieve the above objective, the present disclosure provides a surge protector with an anti-off structure, including a pluggable module and a base. The base includes a pluggable terminal connection part at the bottom and external terminal connection parts on both sides. A pluggable module installation slot is formed in the middle of the base to guide a pin of the pluggable module to insert into the pluggable terminal connection part. The top of the external terminal connection part of the base is provided with a sliding limit device, and both sides of the pluggable module are provided with a fixing limit device.

The direction of inserting the pluggable module into the base is defined as a downward direction.

The sliding limit device includes a hole cover, and the hole cover is slidably connected to the top of the external terminal connection part. When the pluggable module is completely inserted, a part of the hole cover protrudes into the pluggable module installation slot and is clamped with the fixing limit device of the pluggable module to limit the pluggable module from being detached from the base.

Further, the fixing limit device includes a limit protruding block, and a side of the hole cover facing the pluggable module installation slot is provided with a first positioning rib. In an anti-off state, the first positioning rib protrudes into the pluggable module installation slot and abuts the upper surface of the limit protruding block. In an unbuckled state, the first positioning rib slides to leave the pluggable module installation slot and separate from the limit protruding block.

In an embodiment, the sliding limit device further includes an elastic component. The hole cover is slidably connected to the top of the external terminal connection part. Both ends of the elastic component abut the hole cover and the top of the external terminal connection part, respectively, such that the elastic component has an acting force to constantly drive the hole cover to slide horizontally toward the pluggable module installation slot.

Further, the top of the external terminal connection part is provided with a receiving slot configured to place the elastic component, and both ends of the elastic component abut the first positioning rib and a sidewall of the receiving slot, respectively.

In another embodiment, the upper edge of the limit protruding block is provided with a protrusion. When the pluggable module is inserted, the hole cover is slid to form a clamping between the first positioning rib of the hole cover and the protrusion to prevent the hole cover from returning. When the pluggable module is prepared to be removed, the hole cover is slid to overcome the resistance of the clamping between the first positioning rib and the protrusion to allow the hole cover to separate from the limit protruding block.

In the above embodiments, the fixing limit device further includes a limit shaft, and the side of the hole cover facing the pluggable module installation slot is provided with a limit slot. In the anti-off state, the limit shaft is clamped with the limit slot. In the unbuckled state, the limit shaft is separated from the limit slot. The structure is configured to enhance the anti-off strength further.

Further, a side of the hole cover away from the pluggable module installation slot is provided with a second positioning rib. A side of the top of the external terminal connection part away from the pluggable module installation slot is provided with a first limit edge portion and a second limit edge portion, where the first limit edge portion and the second limit edge portion are configured to be clamped with the second positioning rib for position limiting. The second limit edge portion is located on the outer side of the first limit edge portion. When the second positioning rib of the hole cover is clamped with the first limit edge portion, the first positioning rib of the hole cover protrudes into the pluggable module installation slot to form the anti-off state. When the second positioning rib of the hole cover is clamped with the second limit edge portion, the first positioning rib of the hole cover leaves the pluggable module installation slot to form the unbuckled state.

Further, the top of the external terminal connection part is provided with a hole cover sliding slot, and the hole cover is provided with a structure corresponding to the hole cover sliding slot, such that the hole cover is allowed to slide horizontally at the top of the external terminal connection part.

Further, the upper surface of the hole cover is provided with an action part, and the action part is configured to be operated manually to move the hole cover away from the pluggable module installation slot.

Further, the lower surface of the limit protruding block is an inclined surface, and the inclined surface is configured to push away the sliding limit device when the pluggable module is inserted into the base.

Further, guide slots and guide bars matched with each other are arranged between both side edges of the pluggable module installation slot of the base and both side edges of the pluggable module to guide the pluggable module to insert into the pluggable module installation slot.

Compared with the prior art, the advantages of the present disclosure are as follows:

According to the present disclosure, the anti-off function of the surge protector is achieved through the cooperation of slidable hole covers arranged at the tops of both sides of the base of the surge protector and the limit protruding blocks arranged on both sides of the pluggable module. Specifically, when the pluggable module of the surge protector is completely inserted into the base, a part of the hole cover slides to protrude into the pluggable module installation slot and abuts the upper surface of the limit protruding block, to prevent the pluggable module from being detached from the base. When the pluggable module is removed, the part of the hole cover previously protruding into the pluggable module installation slot is returned through sliding, thereby separating from the limit protruding block to allow the pluggable module to be freely removed from the base. The structure is stable and reliable, and the pluggable module cannot be pulled out from the base when the anti-off structure is not unbuckled.

### BRIEF DESCRIPTION OF THE DRAWINGS

To more clearly illustrate the technical solution in the embodiments of the present disclosure or the related technology, the drawings required to be used in the description of the embodiments or related technology are introduced briefly below. It will become apparent that the drawings described below are some of the embodiments of the present disclosure. For those having ordinary skills in the art, additional drawings may also be obtained from the drawings without creative labor.

FIG. 1 is an exploded view of a surge protector of an embodiment of the present disclosure;

FIG. 2 is a schematic diagram showing the structure of a base body of a base in FIG. 1;

FIG. 3 is a schematic diagram showing the structure of a hole cover in FIG. 2;

FIG. 4 is a cross-sectional view of the surge protector in an anti-off state in FIG. 1;

FIG. 5 is a schematic diagram showing the structure of the surge protector in the anti-off state in FIG. 1;

FIG. 6 is a partially enlarged view of detail A circled in FIG. 5;

FIG. 7 is a schematic diagram showing the structure of the surge protector in an unbuckled state in FIG. 1;

FIG. 8 is a partially enlarged view of detail B circled in FIG. 7;

FIG. 9 is a schematic diagram showing the structure of a surge protector in an anti-off state of another embodiment; and

FIG. 10 is a partially enlarged view of detail C circled in FIG. 9.

### DETAILED DESCRIPTION OF THE EMBODIMENTS

The present disclosure provides the drawings for further illustration of the embodiments. The drawings, which are a part of the specification of the present disclosure, are mainly used to explain the embodiments and can be used to explain the operation principle of the embodiments in cooperation with the relevant description of the specification. With reference to these contents, those having ordinary skills in the art should be able to understand other possible embodiments and the advantages of the present disclosure. The components in the drawings are not drawn in proportion, and similar component symbols are often used to represent similar components.

The present disclosure is further explained in combination with the drawings and the specific embodiments.

### Embodiment 1

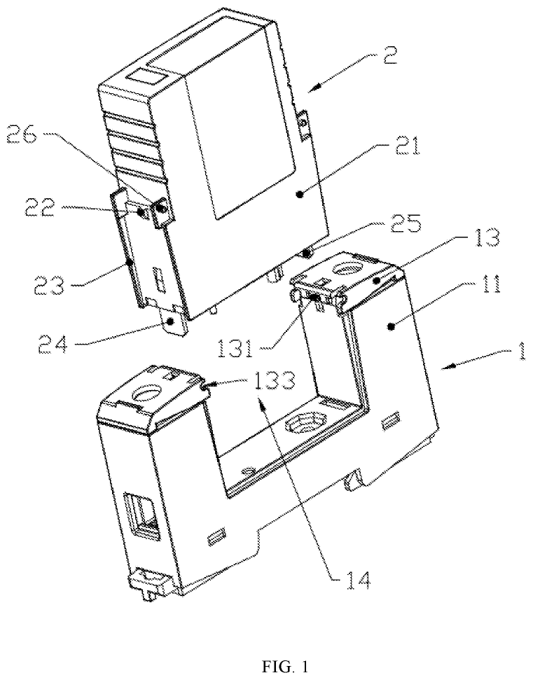

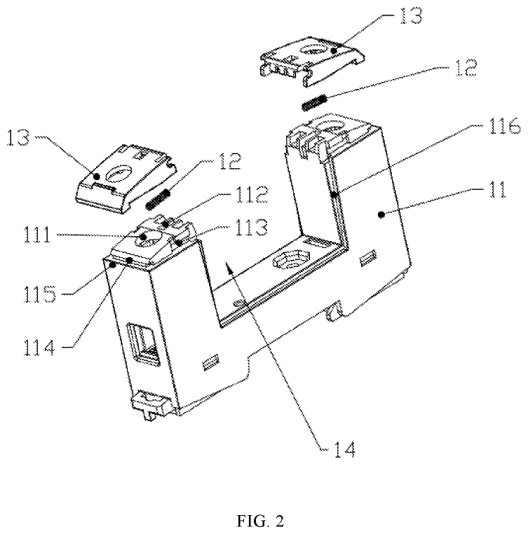

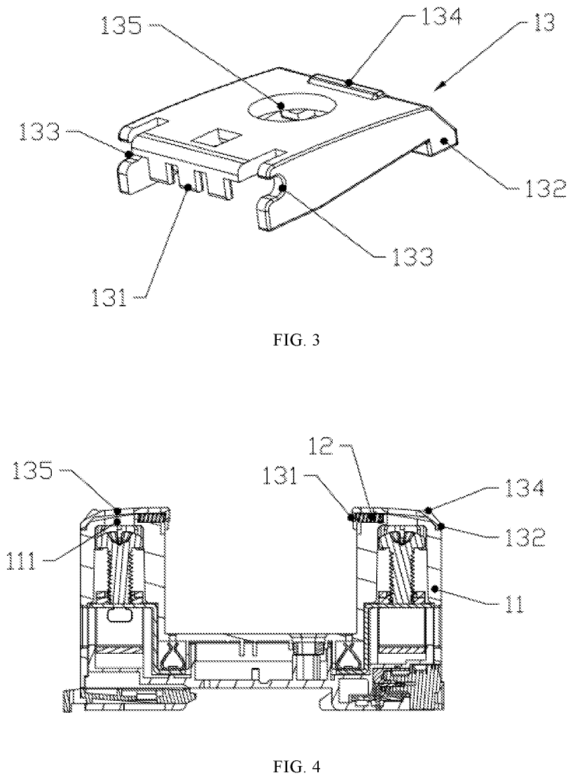

As shown in FIGS. 1-8, the present disclosure discloses a specific embodiment of a surge protector, including the base 1 and the pluggable module 2. The surge protector is provided with an anti-off structure to prevent the well-placed pluggable module 2 from being detached from the base 1. The explanation is as follows:

In the embodiment, the base 1 includes the U-shaped base body 11, a pair of springs 12, and a pair of hole covers 13.

The base body 11 includes the pluggable terminal connection part at the bottom and the external terminal connection parts on both sides. The pluggable module installation slot 14 is formed in the middle of the base body 11 to guide the pin of the pluggable module 2 to insert into the pluggable terminal connection part. Each of the external terminal connection parts on both sides of the base body 11 is provided with the screw operation hole 111 downward from the top.

The pair of hole covers 13 are respectively arranged at the tops of the external terminal connection parts on both sides of the base body 11. The through hole 135 is formed in the middle of the hole cover 13, and the through hole 135 is communicated with the screw operation hole 111, such that the setting of the hole cover 13 does not affect the screwdriver to extend into the screw operation hole 111 to connect the external terminal. The top of the external terminal connection part is provided with the spring receiving slot 112, the hole cover sliding slot 113, the first limit edge portion 114, and the second limit edge portion 115 to connect to the sliding limit device formed by the spring 12 and the hole cover 13. Specifically, the second limit edge portion 115 is arranged on the outer side of the first limit edge portion 114. Both sides of the pluggable module installation slot 14 are further provided with the guide slots 116.

Two ends of the hole cover 13 bend downward to form the first positioning rib 131 and the second positioning rib 132. The hole cover 13 is further provided with a structure corresponding to the hole cover sliding slot 113, such that the hole cover 13 is allowed to slide horizontally at the top of the external terminal connection part.

The spring 12 is arranged in the spring receiving slot 112. One end of the spring 12 abuts the side of the spring receiving slot 112, and the other end of the spring 12 abuts the first positioning rib 131 of the hole cover 13, such that the spring 12 has an acting force to constantly drive the hole cover 13 to slide horizontally toward the pluggable module installation slot 14.

To limit the sliding of the hole cover 13, the second positioning rib 132 of the hole cover 13 is clamped with the first limit edge portion 114 or the second limit edge portion 115 on the outer side (that is, away from the pluggable module installation slot 14) of the top of the external terminal connection part to form an anti-off state or an unbuckled state. The second limit edge portion 115 is located on the outer side of the first limit edge portion 114.

In the embodiment, the pluggable module 2 includes the pluggable module housing 21, the limit protruding blocks 22 and the guide bars 23 arranged on two side surfaces of the pluggable module housing 21, the first pin 24 and the second pin 25 configured to electrically connect the pluggable module 2, and the pluggable terminal connection part of the base 1.

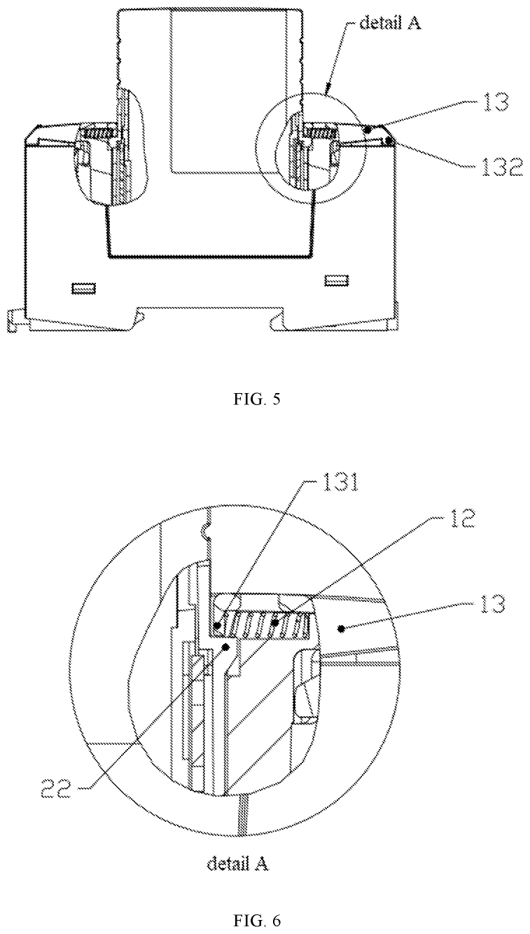

In an anti-off state, the first positioning rib 131 of the hole cover 13 protrudes into the pluggable module installation slot 14 of the base 1 and abuts the upper surface of the limit protruding block 22 of the pluggable module 2 to limit the pluggable module 2 to move upward for removing from the pluggable module installation slot 14 of the base 1. See FIGS. 5-6.

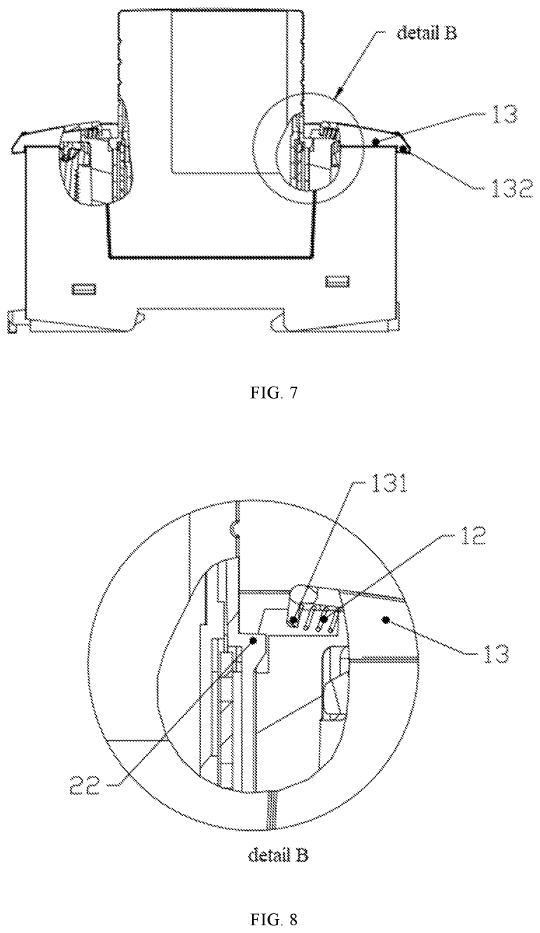

In an unbuckled state, the hole cover 13 moves away from the pluggable module installation slot 14, the second positioning rib 132 moves to be clamped with the second limit edge portion 115, such that the first positioning rib 131 of the hole cover 13 leaves the pluggable module installation slot 14, thereby separating from the upper surface of the limit protruding block 22 of the pluggable module 2 and releasing the limitation on the removal of the pluggable module 2 from the base 1. See FIGS. 7-8.

The upper surface of the limit protruding block 22 defines a planar or an approximately planar surface. The lower surface of the limit protruding block 22 is an inclined surface, and the angle between the inclined surface and the side surface of the pluggable module is 135°-150°.

When the pluggable module 2 is inserted, the limit protruding blocks 22 of the pluggable module 2 can push away the hole covers 13 through the inclined surfaces, such that the pins of the pluggable module 2 are completely inserted into the base 1. When the pins of the pluggable module 2 are already completely inserted into the base, the limit protruding blocks 22 move to be located below the hole covers 13, and the hole covers 13 move horizontally to be located above the limit protruding blocks 22 under the action of the springs 12 and abut the upper surfaces of the limit protruding blocks 22. At the same time, the anti-off state is maintained under the action of the springs 12 to achieve a reliable connection. When the pluggable module 2 needs to be removed from the base 1, the hole covers 13 on both sides are manually moved toward both sides, and then the second positioning ribs 132 of the hole covers 13 are clamped with the second limit edge portions 115, such that the first positioning ribs 131 of the hole covers 13 on both sides leave the pluggable module installation slot 14 to form the unbuckled state. At this time, the pluggable module 2 can be freely removed from the base 1.

In the embodiment, the pluggable module 2 is further provided with the limit shaft 26. The side of the hole cover 13 facing the pluggable module installation slot 14 is provided with the limit slot 133, and the opening of the limit slot 133 faces the pluggable module installation slot 14. In the anti-off state, the limit shaft 26 is clamped with the limit slot 133. In the unbuckled state, the limit shaft 26 is separated from the limit slot 133.

In the embodiment, to facilitate the sliding of the hole cover 13 when the pluggable module 2 is removed, the upper surface of the hole cover is provided with the action part 134. Specifically, the action part 134 is a protruding structure. The operator can exert force through the action part 134 to drive the hole cover 13 to slide to the outer side to achieve the unbuckled state. Specifically, the structure of the action part 134 includes, but is not limited, to a protrusion, a ridge, a groove, etc., as long as it is convenient for the operator to exert force.

In the embodiment, to avoid affecting the setting of the sliding limit device, the guide slots 116 of the pluggable module installation slot 14 are arranged at both side edges of the pluggable module installation slot 14, and correspondingly, both side edges of the pluggable module 2 are provided with the guide bars 23 to guide the pluggable module to insert into the pluggable module installation slot 14.

In the embodiment, the anti-off function of the surge protector is achieved by the cooperation of the slidable hole covers and the springs arranged at the tops of the external terminal connection parts on both sides of the base of the surge protector, and the limit protruding blocks arranged on both sides of the pluggable module. The structure is stable and reliable, and the pluggable module cannot be pulled out from the base when the anti-off structure is not unbuckled.

### Embodiment 2

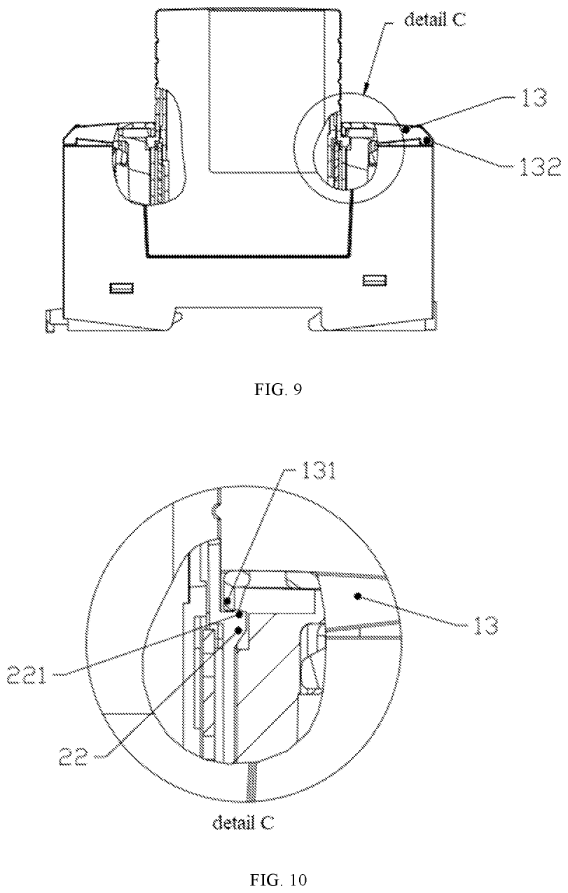

As shown in FIGS. 9 and 10, the present disclosure discloses another embodiment of the surge protector. The difference between this embodiment and Embodiment 1 is the clamping manner of the hole cover 13 and the pluggable module 2.

In the embodiment, the upper edge of the limit protruding block 22 of the pluggable module 2 is provided with the protrusion 221, and no spring is arranged between the hole cover 13 and the base body 11, such that the inward and outward sliding of the hole cover 13 requires manual operation. When the pluggable module 2 is inserted, the first positioning rib 131 of the hole cover 13 is clamped with the protrusion 221 by manually sliding the hole cover 13 to prevent the hole cover 13 from returning. Therefore, the anti-off state is maintained to achieve a reliable connection.

In the embodiment, the anti-off function of the surge protector is achieved by the cooperation of the slidable hole covers arranged at the tops of the external terminal connection parts on both sides of the base of the surge protector, the limit protruding blocks arranged on both sides of the pluggable module and the protrusions arranged on the upper edges of the limit protruding blocks. The structure is stable and reliable, and the pluggable module cannot be pulled out from the base when the anti-off structure is not unbuckled.

Although the present disclosure is specifically demonstrated and introduced in conjunction with the preferred implementation solutions, those skilled in the art should understand that without departing from the spirit and scope of the present disclosure as defined in the appended claims, various changes may be made to the present disclosure in forms and details, which all shall fall within the scope of protection of the present disclosure.

The terms “an embodiment,” “embodiments,” or “one or more embodiments” in this text mean that a particular feature, structure, or characteristic described in combination with the embodiments is included in at least one embodiment of the present disclosure. Furthermore, it should be noted that the term “in the embodiment” here does not necessarily all refer to the same embodiment.

The specification provided here discloses many details. However, it should be understood that the embodiments in the present disclosure can be practiced without these specific details. In some embodiments, the methods, structures, and techniques known to the public are not shown in detail to not obscure the specification's understanding.

What is claimed is:

1. A surge protector with an anti-off structure, comprising a pluggable module and a base; wherein the base comprises a pluggable terminal connection part at a bottom of the base and an external terminal connection part on each of both sides of the base; a pluggable module installation slot is formed in a middle of the base to guide a pin of the pluggable module to insert into the pluggable terminal connection part; a top of the external terminal connection part of the base is provided with a sliding limit device, and each of both sides of the pluggable module is provided with a fixing limit device;
a direction of inserting the pluggable module into the base is defined as a downward direction; and
the sliding limit device comprises a hole cover, and the hole cover is slidably connected to the top of the external terminal connection part; when the pluggable module is completely inserted, a part of the hole cover protrudes into the pluggable module installation slot and is clamped with the fixing limit device of the pluggable module, to limit the pluggable module from being detached from the base.

2. The surge protector with the anti-off structure according to claim 1, wherein the fixing limit device comprises a limit protruding block, and a first side of the hole cover is provided with a first positioning rib, wherein the first side of the hole cover faces the pluggable module installation slot; in an anti-off state, the first positioning rib protrudes into the pluggable module installation slot and abuts an upper surface of the limit protruding block; in an unbuckled state, the first positioning rib slides to leave the pluggable module installation slot and separate from the limit protruding block.

3. The surge protector with the anti-off structure according to claim 2, wherein the sliding limit device further comprises an elastic component; the hole cover is slidably connected to the top of the external terminal connection part; both ends of the elastic component abut the hole cover and the top of the external terminal connection part, respectively, wherein the elastic component has an acting force to constantly drive the hole cover to slide horizontally toward the pluggable module installation slot.

4. The surge protector with the anti-off structure according to claim 3, wherein the top of the external terminal connection part is provided with a receiving slot configured to place the elastic component, and both ends of the elastic component abut the first positioning rib and a sidewall of the receiving slot, respectively.

5. The surge protector with the anti-off structure according to claim 2, wherein an upper edge of the limit protruding block is provided with a protrusion; when the pluggable module is inserted, the hole cover is slid to form a clamping between the first positioning rib of the hole cover and the protrusion to prevent the hole cover from returning; when the pluggable module is prepared to be removed, the hole cover is slid to overcome a resistance of the clamping between the first positioning rib and the protrusion to allow the hole cover to separate from the limit protruding block.

6. The surge protector with the anti-off structure according to claim 2, wherein the fixing limit device further comprises a limit shaft, and the first side of the hole cover is provided with a limit slot; in the anti-off state, the limit shaft is clamped with the limit slot; in the unbuckled state, the limit shaft is separated from the limit slot.

7. The surge protector with the anti-off structure according to claim 2, wherein a second side of the hole cover is provided with a second positioning rib, wherein the second side of the hole cover is away from the pluggable module installation slot; a side of the top of the external terminal connection part is provided with a first limit edge portion and a second limit edge portion, wherein the side of the top of the external terminal connection part is away from the pluggable module installation slot, and the first limit edge portion and the second limit edge portion are configured to be clamped with the second positioning rib for a position limiting; the second limit edge portion is located on an outer side of the first limit edge portion; when the second positioning rib of the hole cover is clamped with the first limit edge portion, the first positioning rib of the hole cover protrudes into the pluggable module installation slot to form the anti-off state; when the second positioning rib of the hole cover is clamped with the second limit edge portion, the first positioning rib of the hole cover leaves the pluggable module installation slot to form the unbuckled state.

8. The surge protector with the anti-off structure according to claim 2, wherein the top of the external terminal connection part is provided with a hole cover sliding slot, and the hole cover is provided with a structure corresponding to the hole cover sliding slot, such that the hole cover is allowed to slide horizontally at the top of the external terminal connection part.

9. The surge protector with the anti-off structure according to a claim 2, wherein an upper surface of the hole cover is provided with an action part, and the action part is configured to be operated manually to move the hole cover away from the pluggable module installation slot.

10. The surge protector with the anti-off structure according to claim 2, wherein a lower surface of the limit protruding block is an inclined surface, and the inclined surface is configured to push away the hole cover when the pluggable module is inserted into the pluggable module installation slot.

11. The surge protector with the anti-off structure according to claim 3, wherein a second side of the hole cover is provided with a second positioning rib, wherein the second side of the hole cover is away from the pluggable module installation slot; a side of the top of the external terminal connection part is provided with a first limit edge portion and a second limit edge portion, wherein the side of the top of the external terminal connection part is away from the pluggable module installation slot, and the first limit edge portion and the second limit edge portion are configured to be clamped with the second positioning rib for a position limiting; the second limit edge portion is located on an outer side of the first limit edge portion; when the second positioning rib of the hole cover is clamped with the first limit edge portion, the first positioning rib of the hole cover protrudes into the pluggable module installation slot to form the anti-off state; when the second positioning rib of the hole cover is clamped with the second limit edge portion, the first positioning rib of the hole cover leaves the pluggable module installation slot to form the unbuckled state.

12. The surge protector with the anti-off structure according to claim 4, wherein a second side of the hole cover is provided with a second positioning rib, wherein the second side of the hole cover is away from the pluggable module installation slot; a side of the top of the external terminal connection part is provided with a first limit edge portion and a second limit edge portion, wherein the side of the top of the external terminal connection part is away from the pluggable module installation slot, and the first limit edge portion and the second limit edge portion are configured to be clamped with the second positioning rib for a position limiting; the second limit edge portion is located on an outer side of the first limit edge portion; when the second positioning rib of the hole cover is clamped with the first limit edge portion, the first positioning rib of the hole cover protrudes into the pluggable module installation slot to form the anti-off state; when the second positioning rib of the hole cover is clamped with the second limit edge portion, the first positioning rib of the hole cover leaves the pluggable module installation slot to form the unbuckled state.

13. The surge protector with the anti-off structure according to claim 5, wherein a second side of the hole cover is provided with a second positioning rib, wherein the second side of the hole cover is away from the pluggable module installation slot; a side of the top of the external terminal connection part is provided with a first limit edge portion and a second limit edge portion, wherein the side of the top of the external terminal connection part is away from the pluggable module installation slot, and the first limit edge portion and the second limit edge portion are configured to be clamped with the second positioning rib for a position limiting; the second limit edge portion is located on an outer side of the first limit edge portion; when the second positioning rib of the hole cover is clamped with the first limit edge portion, the first positioning rib of the hole cover protrudes into the pluggable module installation slot to form the anti-off state; when the second positioning rib of the hole cover is clamped with the second limit edge portion, the first positioning rib of the hole cover leaves the pluggable module installation slot to form the unbuckled state.

14. The surge protector with the anti-off structure according to claim 6, wherein a second side of the hole cover is provided with a second positioning rib, wherein the second side of the hole cover is away from the pluggable module installation slot; a side of the top of the external terminal connection part is provided with a first limit edge portion and a second limit edge portion, wherein the side of the top of the external terminal connection part is away from the pluggable module installation slot, and the first limit edge portion and the second limit edge portion are configured to be clamped with the second positioning rib for a position limiting; the second limit edge portion is located on an outer side of the first limit edge portion; when the second positioning rib of the hole cover is clamped with the first limit edge portion, the first positioning rib of the hole cover protrudes into the pluggable module installation slot to form the anti-off state; when the second positioning rib of the hole cover is clamped with the second limit edge portion, the first positioning rib of the hole cover leaves the pluggable module installation slot to form the unbuckled state.

15. The surge protector with the anti-off structure according to claim 3, wherein the top of the external terminal connection part is provided with a hole cover sliding slot, and the hole cover is provided with a structure corresponding to the hole cover sliding slot, such that the hole cover is allowed to slide horizontally at the top of the external terminal connection part.

16. The surge protector with the anti-off structure according to claim 4, wherein the top of the external terminal connection part is provided with a hole cover sliding slot, and the hole cover is provided with a structure corresponding to the hole cover sliding slot, such that the hole cover is allowed to slide horizontally at the top of the external terminal connection part.

17. The surge protector with the anti-off structure according to claim 5, wherein the top of the external terminal connection part is provided with a hole cover sliding slot, and the hole cover is provided with a structure corresponding to the hole cover sliding slot, such that the hole cover is allowed to slide horizontally at the top of the external terminal connection part.

18. The surge protector with the anti-off structure according to claim 6, wherein the top of the external terminal connection part is provided with a hole cover sliding slot, and the hole cover is provided with a structure corresponding to the hole cover sliding slot, such that the hole cover is allowed to slide horizontally at the top of the external terminal connection part.

19. The surge protector with the anti-off structure according to claim 3, wherein an upper surface of the hole cover is provided with an action part, and the action part is configured to be operated manually to move the hole cover away from the pluggable module installation slot.

20. The surge protector with the anti-off structure according to claim 4, wherein an upper surface of the hole cover is provided with an action part, and the action part is configured to be operated manually to move the hole cover away from the pluggable module installation slot.
